(19) United States
(12) Patent Application Publication
(10) Pub. No.: US 2007/0192220 A1
(43) Pub. Date: Aug. 16, 2007

(54) Method for developing, financing and administering an asset protected executive benefit program

(76) Inventor: Dale K. Edwards, Frederiksted, VI (US)

Correspondence Address: FULBRIGHT & JAWORSKI L.L.P, 2200 ROSS AVENUE, SUITE 2800, DALLAS, TX, 75201-2784, US

(21) Appl. No.: 11/491,776

(22) Filed: Jul. 24, 2006

Related U.S. Application Data
(63) Continuation-in-part of application No. 11/176,429, filed on Jul. 7, 2005.

(51) Int. Cl. G06Q 40/00

(52) U.S. Cl. 705/35

(57) ABSTRACT

A method is provided for developing, financing and administering an asset-protected executive benefit. An employer or Investor makes an investment in an LLC whereby the Employer or Investor becomes the preferred, non-managing member and is entitled to receive a guaranteed payment plus pre-established rate of return. An Executive also makes an investment in the same LLC, becomes a non-preferred, managing member and is entitled to receive value created by the LLC in excess of the amount paid to the preferred member. The LLC invests in, owns, and is the beneficiary of two life insurance policies; a Preferred Policy designed to have a death benefit equal to the investment plus cumulative guaranteed return to the preferred member, and an Investment Policy designed to meet the long-term investment objectives of the members. The Executive may instruct the LLC to borrow against the Investment Policy from which the Executive receives a cash distribution.

### CROSS-REFERENCE TO RELATED APPLICATIONS

The present application claims priority to co-pending U.S. patent application Ser. No. 11/176,429, entitled “Method For Developing, Financing And Administering An Asset Protected Executive Benefit Program,” filed Jul. 7, 2005, the disclosure of which is hereby incorporated herein by reference in its entirety.

### TECHNICAL FIELD

The present invention relates to a process of developing, financing and administering an asset protected executive benefit program.

### BACKGROUND OF THE INVENTION

Saving for retirement as a result of ongoing employment has become challenging, as individuals are becoming accustomed to longer retirement years with a higher standard of living. Higher income executives and business owners often have difficulty finding a safe and reliable investment vehicle that is suitable for their retirement goals. Pre-tax investment options are desirable because they allow the participant to avoid paying income tax on the money invested until after retirement, when the participant is in a lower tax bracket. However, many pre-tax investment options, such as 401(k) plans, IRAs and other qualified plans, limit the amount of annual investment to between $10,500 and $30,000 per year. Other non-qualified retirement plans have significant weaknesses, including the exposure to claims of creditors, and inflexibility in meeting individual objectives. Split dollar life insurance plans have been popular in the past, but the Internal Revenue Service has recently ruled that these plans are subject to certain levels of taxation (unless certain minimum levels of interest are charged), making historical split dollar far less attractive to executives and business owners. These limits and regulations prevent some professionals from meeting their retirement investment goals.

Employers are highly motivated to offer competitive benefits to key employees and executives of the employer. Studies consistently show that employers that provide substantial executive benefits realize lower turnover rates. Studies also consistently show that the economic cost to an employer from the loss of a key employee can be as high 3 to 5 times the annual compensation for the same key employee. However, employers are also limited in what they can provide executives and business owners. Qualified plans have low contribution limits, and non-qualified retirement plans create substantial future liabilities and high costs with little if any cost recovery. Recent IRS rulings on split dollar life insurance make that method unattractive as an incentive offered by employers, and stock options and other equity incentives are less appealing given recent market declines. Finally, employers want the opportunity to create a reasonable rate of return on any funds the employer uses to fund an executive benefit and in some cases want that rate of return to be high enough that outside financing could be secured in lieu of the employer utilizing their own funds. In this way, for employers who realize a high rate of return on invested capital in their own business, they can continue to fund the business as opposed to using precious capital resources to fund a benefit plan.

It is therefore desirable to have a process and design that allows key executives, professionals, and employees the ability, in an asset-protected vehicle, to accumulate wealth for future planned purposes while at the same time allowing the sponsoring employer to receive a competitive and guaranteed rate of return on any funds contributed by the employer. It is also desirable, in some cases, to secure outside financing in lieu of the sponsoring employer utilizing their own capital. It is desirable to accomplish this without substantially limiting the amount that can be invested and that avoids the pitfalls of other options. It is also desirable to have a benefit that provides key executives, employees, employers and other organizations with flexibility, low cost, recovery of their investment plus a rate of return, insulation from creditors and positive accounting treatment.

### BRIEF SUMMARY OF THE INVENTION

With the foregoing in mind, the present invention provides a method for developing, implementing, managing and financing a benefit that takes after-tax investments from both the employer or alternative investor (i.e., Program Sponsor), and the key executive. Specifically, after-tax investments are made into a suitable investment vehicle such as a newly created preferred return LLC (limited liability corporation) by an Employer or outside financing source (the “Investor” collectively and individually with the Employer, the “program sponsor” or “sponsor”) in exchange for owning the preferred, non-managing LLC interests. In addition, after-tax investments are made from a key executive, professional or business owner (the employee or “Executive”) in exchange for owning the non-preferred, managing interests. The amount contributed into the LLC is determined based upon independent appraisal, measuring the value of each LLC interest, and is typically 95% by the Program Sponsor (e.g., Employer or Investor) and 5% by the Executive. The Program Sponsor, as the preferred member, is entitled to receive a guaranteed return of investment and guaranteed rate of return upon liquidation of the LLC, which occurs at the earlier of the death of the Executive (and in some cases their spouses) or 50 years. In this way, embodiments of the invention offer a guaranteed return of capital, plus guaranteed rate of return, on any funds invested by the Program Sponsor. This is unique in the world of executive benefit plans. The Executive is entitled to receive any excess value generated by the LLC, above and beyond the Investor's preferred return, if any.

The LLC is created and domiciled in an “LLC friendly” jurisdiction under state law. Within these states, so long as the capital contributions were made by the Employer or Investor, and Executive outside a “fraudulent convenyance period,” and in the ordinary course of business, then the only recourse to a creditor of the Employer, Investor, or Executive would be a “charging order,” thereby protecting these assets from the claims of creditors. In this way, embodiments of the invention offer a unique level of asset protection previously unavailable in other types of executive benefit plans, such as non-qualified deferred compensation plans.

The Operating Agreement of the LLC (or other suitable investment vehicle, e.g., S Corporation, etc.), as part of the invention, has been designed to accomplish all the various goals of the Employer or Investor, and the Executive. For example, the Operating Agreement stipulates a guaranteed rate of return to the Program Sponsor, the rights and responsibilities of the Executive as LLC Manager, the manner in which profits and losses are allocated, and the manner in which the LLC is liquidated.

The LLC, under the direction of the Executive as the non-preferred managing member, and within the auspices of the Operating Agreement of the LLC, oversees and manages the investments of the LLC. One of those investments preferably may be a life insurance policy known as the “Preferred Policy.” The Preferred Policy typically will insure the Executive and his/her spouse, although other insureds are possible as long as an insurable interest exists under state law. The Preferred Policy, as part of the invention design, is designed selected and/or managed to always have a death benefit equal to the investment made by the Program Sponsor, as well as all accumulated preferred return due to the Program Sponsor. This Preferred Policy may be issued by a leading AA or AAA rated carrier, and serves as the mechanism to ensure that the Program Sponsor receives their guaranteed payment at liquidation.

The LLC, under the direction of the Executive as non-preferred managing member, and after purchasing the Preferred Policy, may take any remaining capital and purchase a life insurance policy known as the “Investment Policy.” The Investment Policy may be designed to provide future retirement income to the Executive. At a future time stipulated by the Operating Agreement of the LLC, the Executive as manager can require the LLC to borrow funds against the Investment Policy. This methodology is the first believed to consider how life insurance policies owned by LLCs can consider and manage borrowings against that policy as part of an executive benefit program. Specifically, features of the benefit program, including the operating agreement, provide for the borrowing of funds against the Investment Policy to be characterized as non-recourse debt under and consistent with the U.S. tax code. Non-recourse and Excess non-recourse debt can be allocated to a member of an LLC, which is taxed as a partnership, under Reg. Sec. 1.752-3. In this way, the Executive's basis is increased by the amount of the borrowings against the Investment Policy, thereby allowing the Executive to receive distributions from the LLC that does not exceed their basis in the LLC.

Upon the death of the insured, which is typically the Executive and his/her spouse, the LLC calls for the allocation of tax-free death benefits from a life insurance policy. The present benefit program including the operating agreement, consistent with U.S. tax code, allocates this tax-free income in such a way that the remaining and final distributions, both to the Program Sponsor, and the Executive, does not exceed their respective basis.

Thus, the present benefit program simultaneously accomplishes the objectives of both parties. For the Employer (or, more generally, Program Sponsor), any investment in the LLC results in a guaranteed return on investment in the form of tax-free income upon the death of the Executive and his/her spouse. The level of return to the Employer is sufficient to offer an attractive rate of return that is “investment grade” in nature. The rate of return is also sufficient so that the Employer could seek out and secure an outside lender to provide the funds for the LLC investment. This is attractive for many Employers who have rates of return on invested capital in excess of the rate of return they would experience through the invention. In addition, for the Employer, the key members of management have any additional incentive to remain employed, which is extremely valuable to the Employer. Finally, for the Employer, the assets invested in the invention are protected from the claims of creditors, with certain conditions. For the Executive, the present benefit program allows for the accumulation of asset-protected assets that can then be accessed by the Executive in the form of tax-advantaged distributions, so long as the preferred return to the Employer or Investor is first met. The present benefit program accomplishes the objectives of both parties.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a diagram illustrating the major components of a method for developing, financing and administering an asset-protected executive benefit program (“benefit program”);

FIGS. 2a-2e are diagrams illustrating a sequence of steps for implementing the method shown in FIG. 1;

FIG. 3 is a chart of variable assignments and information used and generated by a benefit program according to an embodiment of the invention;

FIG. 4 is a flow chart of a process according to an embodiment of the invention for maximizing cash value performance while minimizing death benefit and mortality costs of a benefit program;

FIG. 5 is a display screen according to an embodiment of the invention used by a client to input data to a computer or data processing system for developing, financing and administering an asset-protected benefit plan including marginal references labeling variables as presented in FIG. 3;

FIG. 6 is a display screen according to an embodiment of the invention in the form of a spreadsheet showing the results of calculations performed by the system of FIG. 5 including premium, loan amount and interest, outlay, policy net and surrender values and death benefit for years 1-40;

FIG. 7 is a display screen according to an embodiment of the invention in the form of a spreadsheet showing the results of calculations performed by the system of FIG. 5 including Employer of Financing Source, Executive and Capitalization and Preferred Policy calculations;

FIG. 8 is a display screen according to an embodiment of the invention in the form of a spreadsheet showing the results of calculations performed by the system of FIG. 5 including Capitalization and Preferred Policy calculations;

FIG. 9 is a display screen according to an embodiment of the invention in the form of a spreadsheet showing the results of calculations performed by the system of FIG. 5 including a annual breakdowns of amounts invested by each LLC member;

FIG. 10 is a display screen according to an embodiment of the invention in the form of a spreadsheet showing the results of calculations performed by the system of FIG. 5 including alternative investment baseline calculations for years 1-40;

FIG. 11 is a display screen according to an embodiment of the invention in the form of a spreadsheet showing the graphical comparison between the LLC investment strategy versus an alternative investment vehicle/strategy as might be display to a user by the system of FIG. 5;

FIG. 12 is a display screen according to an embodiment of the invention in the form of a spreadsheet showing the results of calculations performed by the system of FIG. 5 including the rate of return to the employer;

FIG. 13 is a display screen according to an embodiment of the invention in the form of a spreadsheet showing a comparison between self finance versus outside financing vehicles as might be computed and displayed by the system of FIG. 5;

FIG. 14 is a display screen according to an embodiment of the invention in the form of a spreadsheet showing the results of calculations performed by the system of FIG. 5 including an analysis of a capital account;

FIG. 15 is a flowchart of method steps for presenting and implementing the benefit program consistent and in accordance with the parameters, selections, and calculations performed according to the method at FIG. 4;

FIG. 16 is a block diagram of a system according to an embodiment of the invention providing for creation and implementation of a benefit program including collection of information from the employee, employer, investor, program sponsor, and other sources, and the ongoing administration and monitoring of the program by the parties; and

FIG. 17 is a block diagram of a computer system that may be used as a platform in support of software performing steps and methods according to various embodiments of the invention.

### DETAILED DESCRIPTION OF THE INVENTION

The process can be used for key members of management, professionals, business owners, and other persons. More specifically, the present invention relates to a benefit in which the employer or alternative investor source (e.g., a sponsor of the program) co-invests in an investment vehicle, e.g., a Limited Liability Company (“LLC”) with a key executive of the employer, with the LLC making investments in a variety of financial instruments including life insurance. The employer of outside investor is entitled to receive a return of their investment, plus a guaranteed rate of return, and the key executive is entitled to receive any excess LLC value, in the future, in the form of distributions of cash.

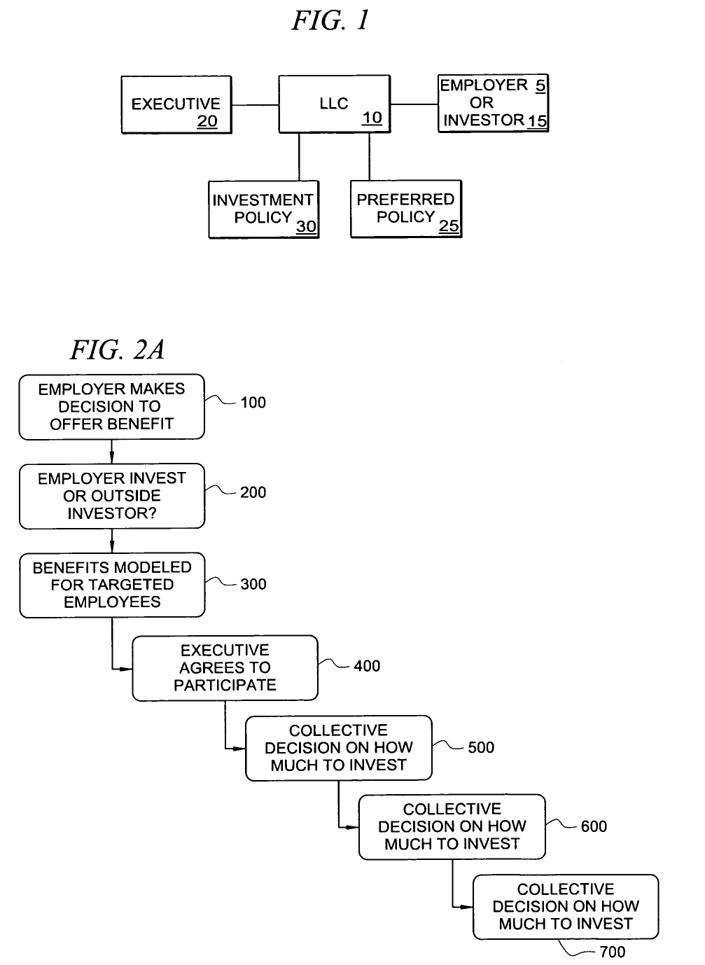

Referring to FIG. 1, an example of a method for developing, financing and administering an asset-protected executive benefit according to an embodiment of the invention is illustrated. Employer 5 either makes a pre-determined annual investment of after-tax cash into a limited liability corporation (LLC) 10, or seeks out and secures financing from an outside Investor 15 to do the same. Employer 5 or Investor 15 (individually and/or collectively the “program sponsor” or more simply “Sponsor”) typically makes a commitment to invest a predetermined annual amount into LLC 10 for a minimum period, typically of 5 to 10 years. Employer 5 or Investor 15 purchases and owns the preferred, non-managing interests in LLC, entitling Employer 5 or Investor 15 to receive a guaranteed return on their investment upon the liquidation of LLC. Executive 20 also makes an investment with after-tax cash and purchases, at fair-market value, the non-preferred managing interests of LLC such that distributions are subject to the prior rights of the Program Sponsor. This entitles Executive 20 to receive any value generated by LLC that exceeds the preferred return due to Employer 5 or Investor 15.

LLC invests in, owns, and is the beneficiary of two life insurance policies. The first policy, the Preferred Policy 25 is engineered as part of the benefit program to always have a death benefit equal to the investment plus guaranteed return due to the Employer 5 or Investor 15. The Preferred Policy will typically insure the lives of Executive 20 and his/her spouse. The LLC Operating Agreement stipulates that funds within the LLC 10 must first be used to adequately fund the Preferred Policy 25. Any remaining LLC 10 funds are used to purchase an Investment Policy 30 that is engineered as part of the benefit program to create cash value in the future. The Investment Policy 30 will typically insure the life of Executive 20.

Premiums paid into Investment Policy 30 accumulate into cash value that may earn interest and grow tax free. After an initial premium funding period, Executive 20 may instruct LLC 10 to borrow against Investment Policy 30, which is an assumption of non-recourse debt by the LLC 10. The LLC 10 will then allocate this non-recourse debt to the Executive 20, resulting in the basis of Executive 20 in LLC 10 being increased by the same amount. Executive 20 will then receive a cash distribution from LLC 10 which not to exceed the basis of Executive 20.

Upon the death of the insured from the Preferred Policy 25 and the Investment Policy 30, LLC 10 as beneficiary receives the tax-free death benefits. LLC 10 then allocates this tax-free income to Employer 5 or Investor 15 (as the case may be), as well as to Executive 20, thus increasing the basis for each of these members or “parties”. The result is a final distribution from the LLC 10 to each of the members equal to their respective basis.

The method for developing, financing and administering an asset-protected executive benefit program will now be described in more detail. An Employer 5 determines that it is in the best interests of the Employer 5 to offer a benefit plan to key employee(s) or executive(s) of Employer 5. An analysis is then performed to determine if it is economically best for Employer 5, to fund the LLC 10 interests directly or to seek funds from an outside Investor 15. This analysis reviews the historical rate of return on invested capital experienced and or expected by Employer 5 and compares it to an actuarial and present value analysis of the return to be expected by the Employer 5 from the LLC 10 investment. Based on this analysis, a determination is made if it is best for Employer 5 or same Outside Investor 15 to make the investment in LLC 10.

The benefit program is then presented to the targeted employees to determine their level of interest. An analysis is conducted to show the targeted employee the potential economic benefits from the benefit program versus other types of personal savings or employer-sponsored benefit plans. Those targeted employees who elect to participate then move on to the next step.

Employer 5 or Investor 15, along with Executive, 20, then make a collective decision as to how many years and for how much to find LLC 10. An appraisal is then conducted to determine the fair-market value of the preferred interests to be held by Employer 5 or Investor 15, as well as the fair-market value of the non-preferred interests to be held by Executive 20. Employer 5 or Investor 15, along with Executive 20, then collectively agree to invest this amount, with after-tax funds, into LLC 10 for an agreed upon period of years.

LLC 10 is then formed in an asset-protection friendly state jurisdiction by filing articles of organization, by-laws, and other state-specific filings to the appropriate state authorities. In addition, a bank account is opened by LLC 10 from which it receives capital contributions, makes premium payments, pays other expenses, and receives proceeds from life insurance policy investments.

A software system is then used to design the Preferred Policy 25 so that it always has a death benefit equal to the investment made by the Employer 5 or Investor 15, plus all accrued preferred return. According to a preferred embodiment, the software system may be implemented on a personal computer (PC) using conventional spreadsheet software as Microsoft®, Excel® and financial functions provided by the application. This software system provides the data necessary to create a policy illustration to be submitted to the life insurance company issuing the Preferred Policy 25 along with an application. LLC 10 applies for the Preferred Policy 25, together with Executive 20, along with his/her spouse, typically being the insured lives for the Preferred Policy 25. Once the underwriting requirements set by the insurance company are satisfied, Preferred Policy 25 is issued by the insurance company to LLC 10 as the owner and beneficiary.

A software system is then used to design the Investment Policy 30 so that it meets the investment objectives of the managing member, i.e., Executive 20. This software system provides the data necessary to create a policy illustration to be submitted to the life insurance company issuing the Investment Policy 30 along with an application. LLC 10 applies for the Investment Policy 30, with the Executive 20, typically being the insured for the Investment Policy 30. Once the underwriting requirements set by the insurance company are met, the Investment Policy 30 is issued by the insurance company to LLC 10 as the owner and beneficiary.

Once both Preferred Policy 25 and Investment Policy 30 have been issued to LLC 10 by the respective life insurance carriers, LLC Operating Agreement is drafted and executed by Program Sponsor (i.e., Employer 5 or Investor 15) as the preferred non-managing member, as well as by Executive 20 as non-preferred managing member. As part of the terms of LLC Operating Agreement, each party agrees to invest a certain amount of after-tax funds into LLC 10 for a minimum number of years, typically 5-10 years. LLC Operating Agreement also stipulates the guaranteed rate of return due to the Program Sponsor (Employer 5 or Investor 15), the manner in which profits and losses will be allocated, the manner in which non-recourse and excess non-recourse debt will be allocated, and several other issues.

Upon execution of LLC Operating Agreement, Employer 5 or Investor 15, along with Executive 20 make their respective after-tax capital contributions into LLC 10. LLC 10 then uses these funds to (i) first pay premiums on the Preferred Policy 25, with any excess funds used to (ii) pay premiums on Investment Policy 30.

Employer 5 or Investor 15, along with Executive 20, continue to make capital contributions into LLC 10 for the previously agreed upon investment period as stipulated in LLC Operating Agreement. LLC continues to make premium investments first into Preferred Policy 25, and then into Investment Policy 30.

Executive 20, as managing member, actively oversees the policy investments made by LLC 10 including, in some cases, making changes in investment allocations within the Investment Policy 30. LLC 10 typically conducts no less than one annual meeting a year to include Program Sponsor (Employer 5 or the Investor 15) along with Executive 20. In addition, LLC 10 files an annual tax return reflecting the investment activity of LLC 10.

The face amount of the Preferred Policy 25 increases each year such that the Preferred Policy always has a death benefit equal to the initial investment, plus all guaranteed preferred return, due back to Employer 5 or Investor 15.

Investment Policy 30 (typically a universal life policy with some form of investment feature) performs over time based on the interaction of several variables. The Investment Policy 30 premiums and market gains or other insurance company crediting contribute to growth of a cash value in the policy. Gains, however, are offset by costs, including costs of the insurance, loads, commissions, premium taxes and administrative fees assessed by the insurance company. Gains can also offset by market losses. Regardless of the actual performance of Investment Policy 30 however, and so long as the Preferred Policy 25 has a death benefit equal to the preferred member's investment plus guaranteed return, the Executive 20 as managing member of the LLC can instruct the LLC 10 to borrow against the cash value of Investment Policy 30.

After the initial LLC 10 capitalization period, Executive 20 may instruct LLC 10 to borrow against the cash value in Investment Policy 30. This borrowing represents an assumption of non-recourse debt by the LLC 10. LLC 10 then will allocate this non-recourse debt, along with excess non-recourse debt, to the basis of Executive 20 in LLC 10. This increase in the basis Executive 20 will allow Executive 20 to receive a distribution of cash from LLC 10 equal to that same increase in basis. Executive 20 is eligible to instruct LLC 10 to do this at any time after the initial LLC 10 capitalization period.

A program administrator will monitor this borrowing activity against the Investment Policy 30 and advise Executive 20 as to the impact of borrowings on future policy performance. In addition, a program administrator will monitor and report annual LLC 10 activity including adjustments in capital accounts, basis, policy values, rates of return, and other indicators.

Upon the death of the insured lives (i.e., the death of the Executive and, if insured, his/her spouse) for the Preferred Policy 25 and Investment Policy 30, LLC 10 as owner and beneficiary will receive tax-free death benefit proceeds. LLC 10 will then allocate these funds to the Program Sponsor (Employer 5 or Investor 15) along with Executive 20, thereby increasing the basis for these LLC members. LLC will then distribute these funds first to the Program Sponsor (Employer 5 or Investor 15) in an amount equal to their initial investment plus cumulative guaranteed return. Any remaining funds with be distributed to the estate of Executive 20. The business affairs of LLC 10 will then be completed and LLC 10 will be dissolved.

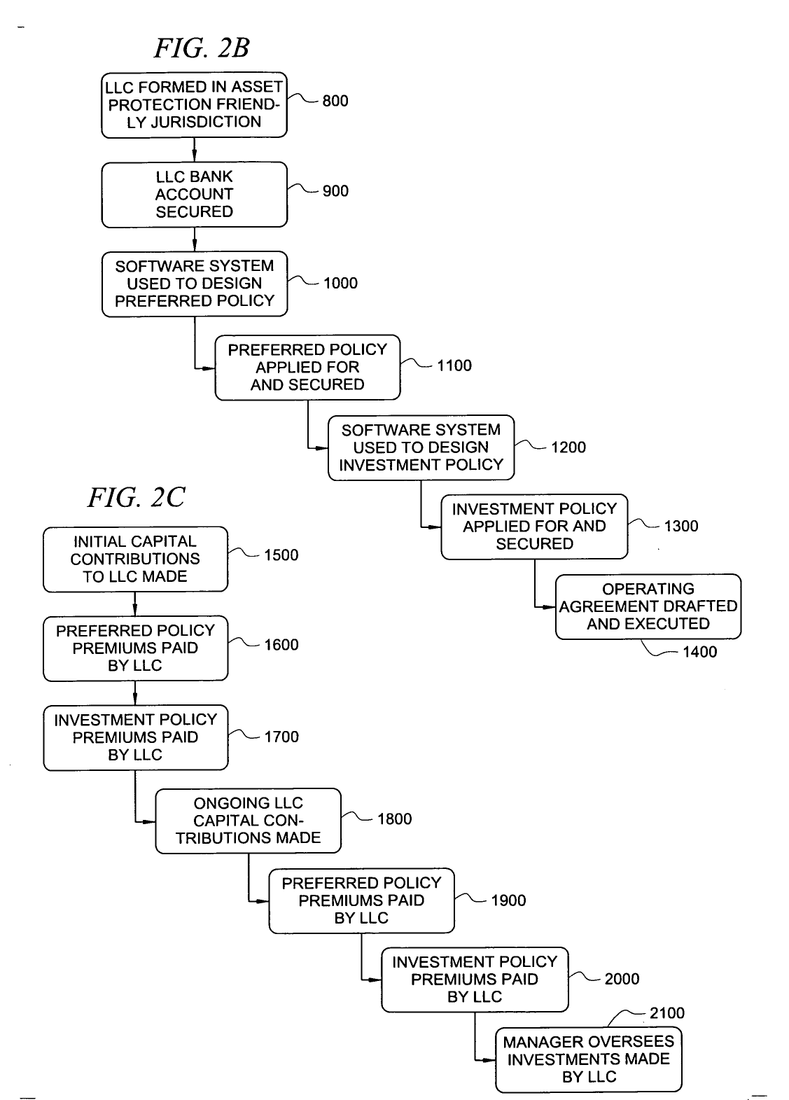

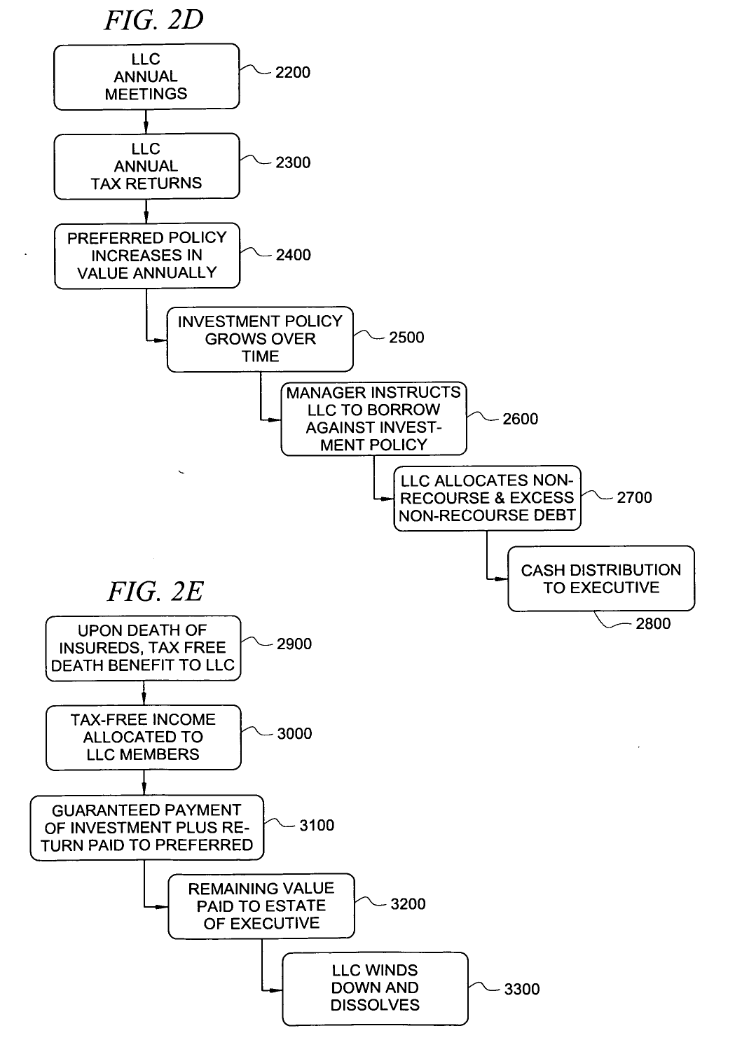

Referring now to FIGS. 2a-2e, a method for developing, financing and administering an asset-protected executive benefit program is illustrated in a block-flow diagram. The method begins with an Employer making a decision that offering the benefit to a certain number of key employees is in the best interests of the Employer 100. A software system is then used to determine if it is best for the Employer, economically, to make the LLC investment itself, or secure financing from an outside Investor to make the LLC investment 200. The benefit is then presented to targeted key employees using a software system that forecasts the potential benefits of the benefit versus other options 300, and interested key employees make a decision to move forward at step 400.

The Program Sponsor (Employer or Investor) along with the Executive make a collective decision as to how much to invest in the LLC at step 500. An outside appraisal then determines how much each party should invest in the LLC as determined by fair-market value at step 600. The parties then agree collectively as to how many years each is willing to make investments into LLC at step 700.

LLC is formed and organized in an asset-protection friendly jurisdiction 800, and a bank account for LLC is secured.

A software system (e.g., PC with suitable financial spreadsheet application software) is then utilized to design the Preferred Policy at step 1000. The Preferred Policy is then applied for and secured from the insurance company issuing the Preferred Policy at step 1100. A software system is then utilized to design the Investment Policy at step 1200. The Investment Policy is then applied for and secured from the insurance company which issues the Investment Policy at step 1300.

Once the Investment Policy and Preferred Policy have been issued by their respective insurance carriers, the LLC Operating Agreement is drafted and executed at step 1400. Upon execution of the LLC Operating Agreement, the Employer or Investor, along with the Executive, make their initial LLC capital contributions at step 1500. These capital contributions are then used to first pay premiums on the Preferred Policy at step 1600, with any remaining funds used to pay premiums on the Investment Policy at step 1700. The Employer or Investor, along with the Executive, then continue to make LLC capital contributions per the LLC Operating Agreement at step(s) 1800, and the LLC continues to make premium investments first into the Preferred Policy at step(s) 1900, and then into the Investment Policy at step(s) 2000.

The Executive as managing member actively oversees the investments owned by the LLC, and in some cases makes investment re-allocations within the Investment Policy at step 2100. In addition, the LLC conducts annual meetings at step 2200 and files annual tax returns at step 2300.

It is expected that the Preferred Policy death benefit will increase in value on an annual basis by an amount equal to the cumulative preferred return due back to the Employer or Investor as shown at step 2400. In addition, the Investment Policy cash value typically will grow in value over time 2500. The Executive, in the future, may elect to instruct the LLC to borrow money from the Investment Policy, which is an assumption of non-recourse debt by the LLC at step 2600. The LLC then allocates non-recourse and excess non-recourse debt to the Executive's basis at step 2700, and the Executive then takes a cash distribution from the LLC which does not exceed basis at step 2800.

Upon the death of the insured the LLC, as owner and beneficiary of the policies, receives tax-free death benefits at step 2900. The LLC then allocates this tax-free income to the basis of the LLC members at step 3000. The LLC then distributes to the Employer or Investor an amount equal to their initial investment plus cumulative guaranteed return at step 3100. Any remaining amount is distributed to the Executive's estate at step 3200, and the LLC then winds down and dissolves at step 3300.

The steps shown in FIGS. 2a-2e and described above are not intended to represent a preferred sequence of steps. Rather, FIGS. 2a-2e and the foregoing description are intended to illustrate the component steps of the present method in one possible sequence, with the understanding that minor variations in the sequence can be made without substantially changing the method. In addition, the terms and expressions which have been employed are used as terms of description and not of limitation. There is no intention in the use of such terms and expressions of excluding any equivalents of the steps or features shown and described or portions thereof. It is recognized that various modifications of the disclosed method are possible within the scope and spirit of the invention.

For instance, other separate parties who have a business, family or other relationship may have a reason to jointly invest in an the LLC arrangement described herein, and utilize the insurance policy structure described in this method.

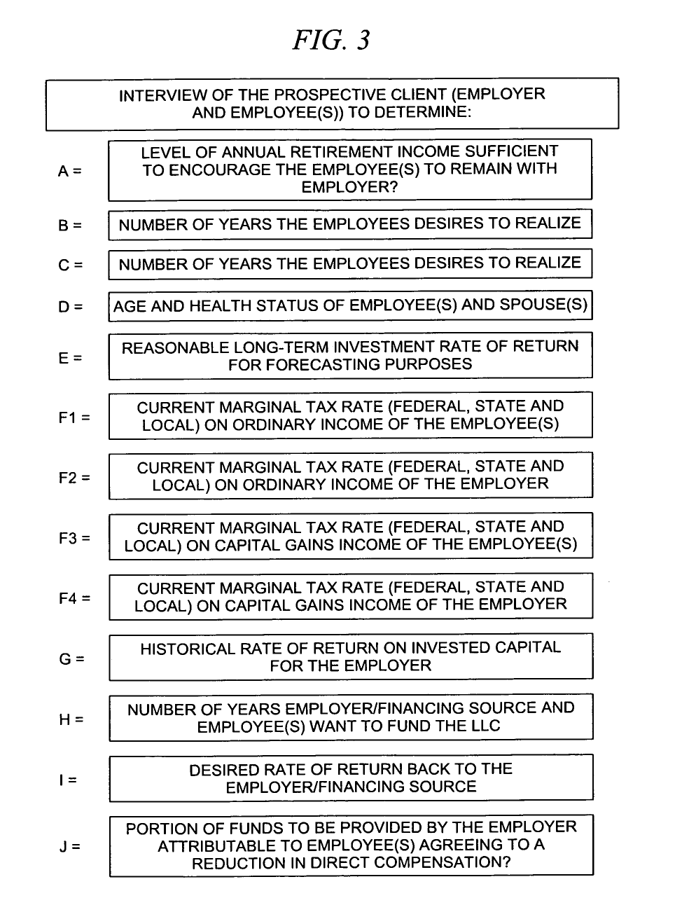

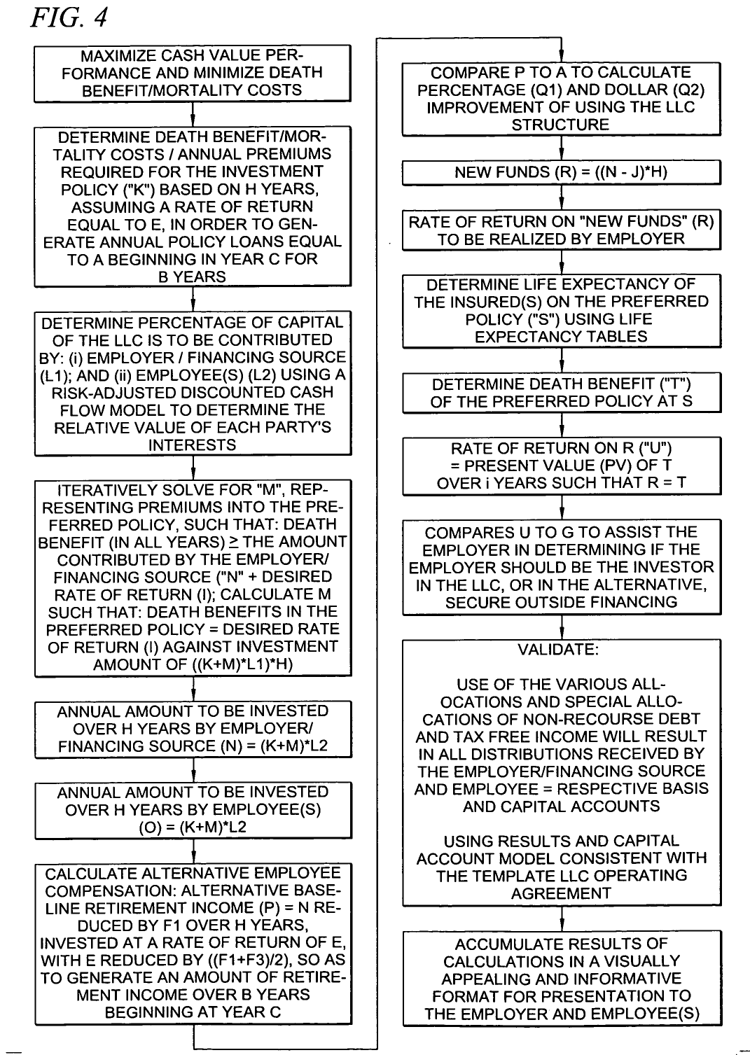

An implementation of a method according to an embodiment of the invention using a computer to perform or assist in the performance of the various steps and, in particular, crafting and selection of the life insurance policies will now be described with reference to FIGS. 3 and 4. FIG. 3 is a chart of variable assignments and information used to select an appropriate investment instrument, in this case, a life insurance policy. Various pieces of information are gathered by conducting interviews with the various parties (e.g., the employee or “Executive”, the Employer, and/or Investor). An initial interview of the prospective client (Employer and Employee(s)) is used to determine/assess:
“A”: A level of annual retirement income that would be sufficient to encourage the Employee(s) to remain with the Employer. This retirement income is designated herein and in the following figures as “A”.
“B”: The number of years at income level A that the employee desires to realize.
“C”: The year in which disbursement of retirement A is to start.
“D”: Present age and health status of the employee(s) and spouse(s).
“E”: A predicted long-term investment rate of return to be used for forecasting purposes.
“F”: The current marginal tax rate (Federal, State and Local) on ordinary income of the employee(s) (“F1”) and employer (“F2”). The current marginal tax rate (Federal, State and Local) on capital gains income of the employee(s) (“F3”) and employer (“F4”).
“G”: The historical rate of return on invested capital achieved/obtained by the employer.
“H”: The number of years that the employer/financing source and employee(s) want to fund the LLC.
“I”: The desired rate of return back to the employer/financing source.
“J”: Dollar amount of funds to be provided by the employer, if the employer finances the LLC, so as to result in the employee(s) agreeing to a lower compensation.

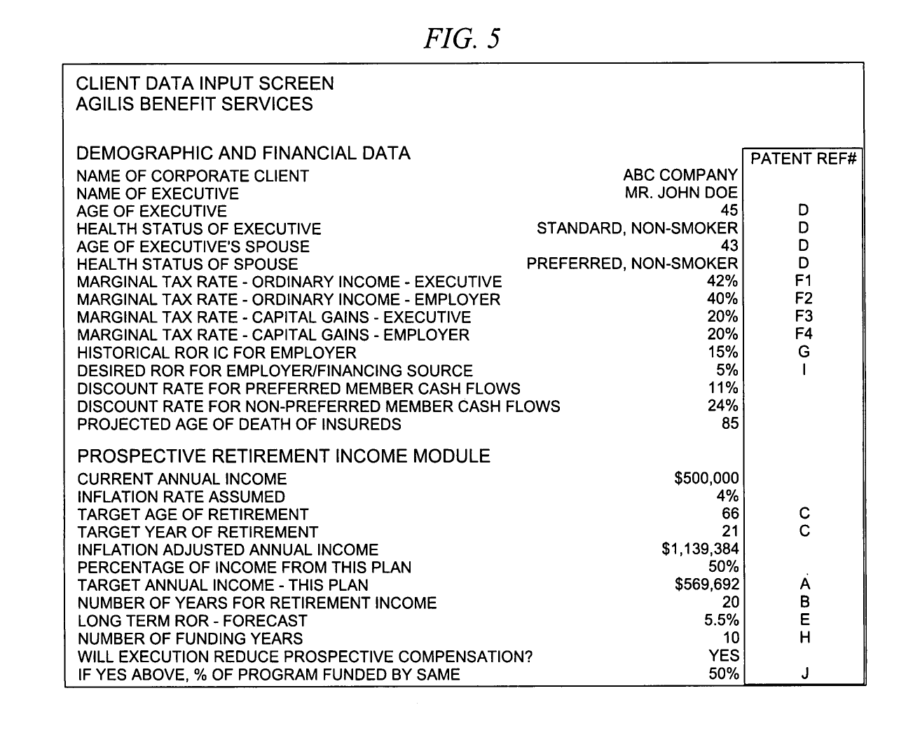

FIG. 4 is a flow chart of a process according to an embodiment of the invention for maximizing cash value performance while minimizing death benefit and mortality costs and selecting an appropriate investment vehicle such as the aforementioned insurance policy. According to a preferred embodiment, the software may be implemented using a spreadsheet such on a Microsoft® Excel® platform as shown, by way of example, in FIG. 5, wherein the values for the various parameters to be described may be input and displayed. For each of reference, the parameters are alphabetically labeled and referenced in the following description and figures.

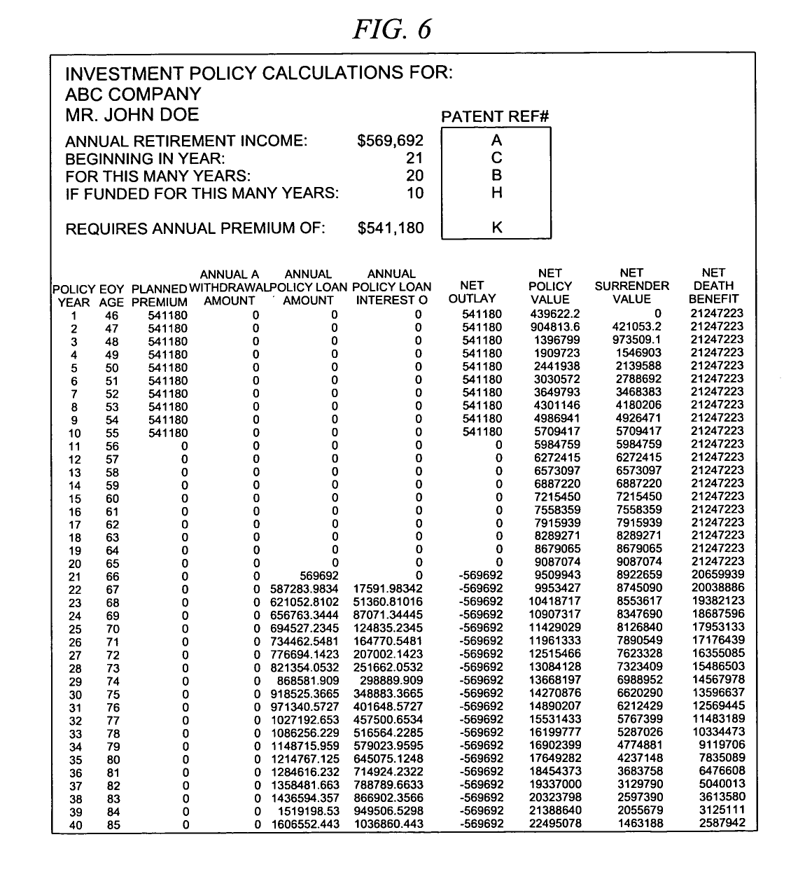

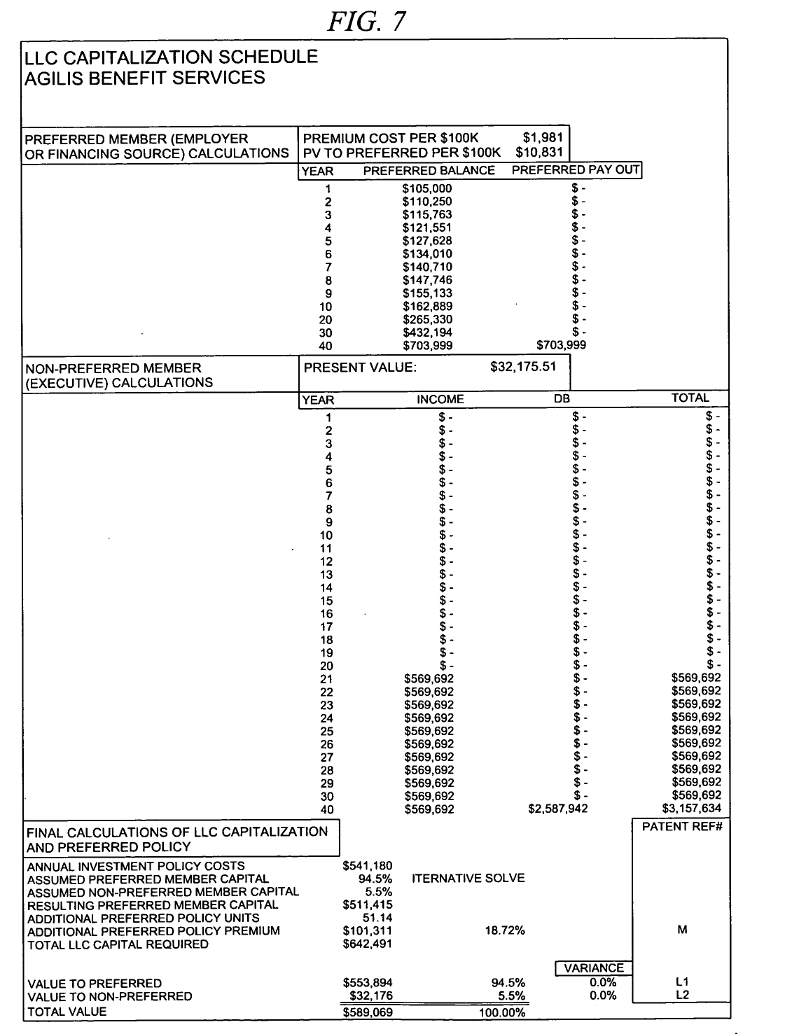

Referring to FIG. 4, the Investment Policy is designed to maximize cash value performance and minimize death benefit/mortality costs. A life insurance policy illustration on the Investment Policy is run on the Executive (or “Employee”) at step 402 in order to determine how much annual premium will be required over H years, assuming a rate of return equal to E, in order to generate annual policy loans equal to “A” beginning in year “C” for “B” years. This result is “K”, the annual premiums required for the Investment Policy. FIG. 6 illustrates a computer display of a spreadsheet with these calculations performed and displayed over some period (e.g., B+C−1) in this case for years 1-40.

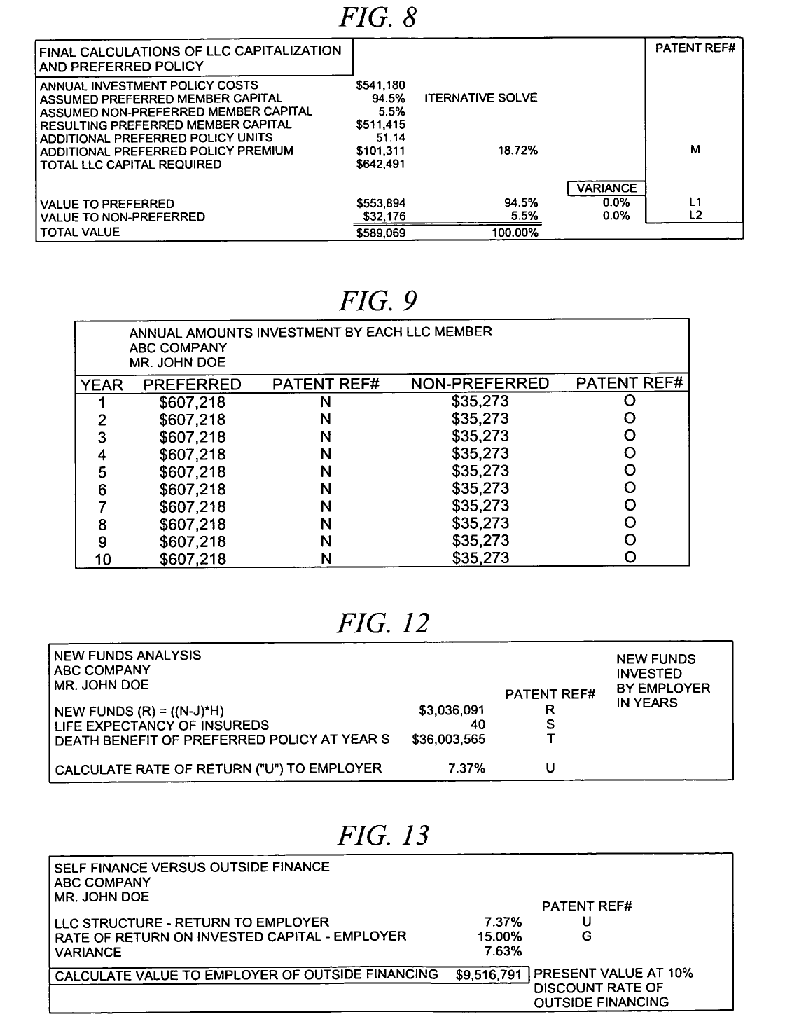

At step 403 the system determines how much of the capital of the LLC, as a percentage, needs to be contributed by the Plan Sponsor, i.e., b the Employer/financing source, and how much as a percentage needs to be contributed by the Employee. The software contributed by the Employee is “L2.” L1 plus L2 will always equal 100%. FIG. 8 illustrates a computer display of a spreadsheet with capitalization schedules computed over the period of interest for both the Employer or Financing Source and the Executive together with a set of overall, final calculations discussed above for the period of interest (e.g., years 1-40).

At step 404 the software is configured (e.g., programmed) to use an iterative solve process, whereby “M”, representing premiums into the Preferred Policy, is solved. The Preferred Policy is designed to always have a death benefit (in all years) equal to the amount contributed by the employer/financing source (see “N” below) plus a rate of return equal to “I”. This involves the software calculating “N” plus the annual value of “I”, and then designing the policy so that the death benefit in each year equals or exceeds this amount. The software calculates the amount of “M” necessary such that the death benefits in the Preferred Policy will equal a rate of return of “I” against an investment amount of ((K+M)*L1)*H). FIG. 8 illustrates a computer display of the results of these calculations.

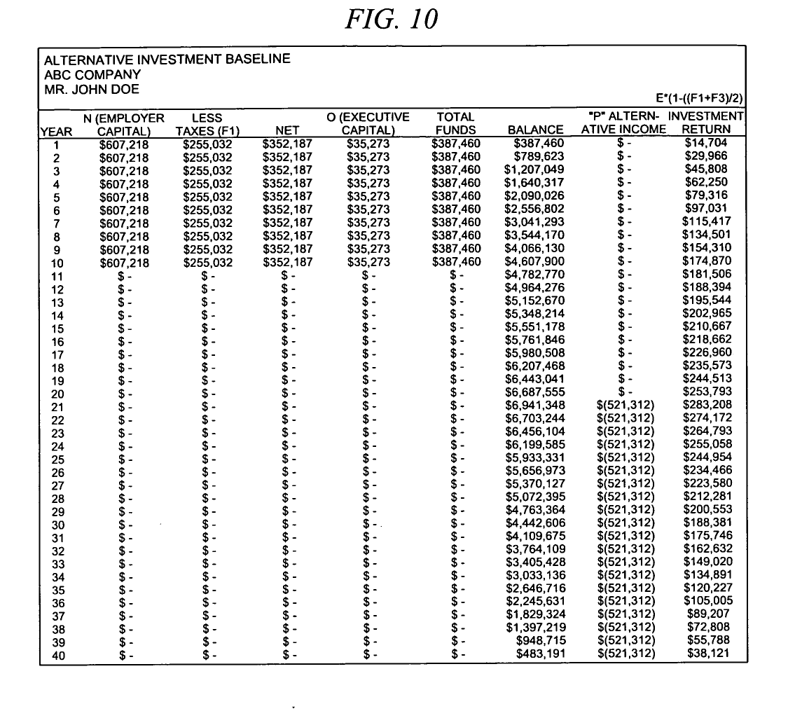

The annual dollar amount to be invested over H years by the Employer/Financing source is then calculated at step 405 to be equal to (K+M)*L1. This amount is “N.” Similarly, at step 406, the annual dollar amount to be invested over “H” years by the Employee is calculated to be equal to (K+M)*L2. This amount is “O.” FIG. 10 illustrates a computer display of a spreadsheet showing annual amounts invested by each LLC member (i.e., “party”) over the investment period, e.g., the first ten years of the overall period.

At step 407 a comparative forecast for the Employee is calculated. This is based on an assumption that the Employee could, in the alternative, receive an amount N from their Employer as taxable ordinary income. N reduced by F1 over H years, invested at a rate of return of E, with E reduced by ((F130 F3)/2), will generate a certain amount of retirement income over B years beginning at year C. This becomes a baseline retirement income number that the LLC structure is then compared to in the next step. This baseline amount of retirement income is “P.”

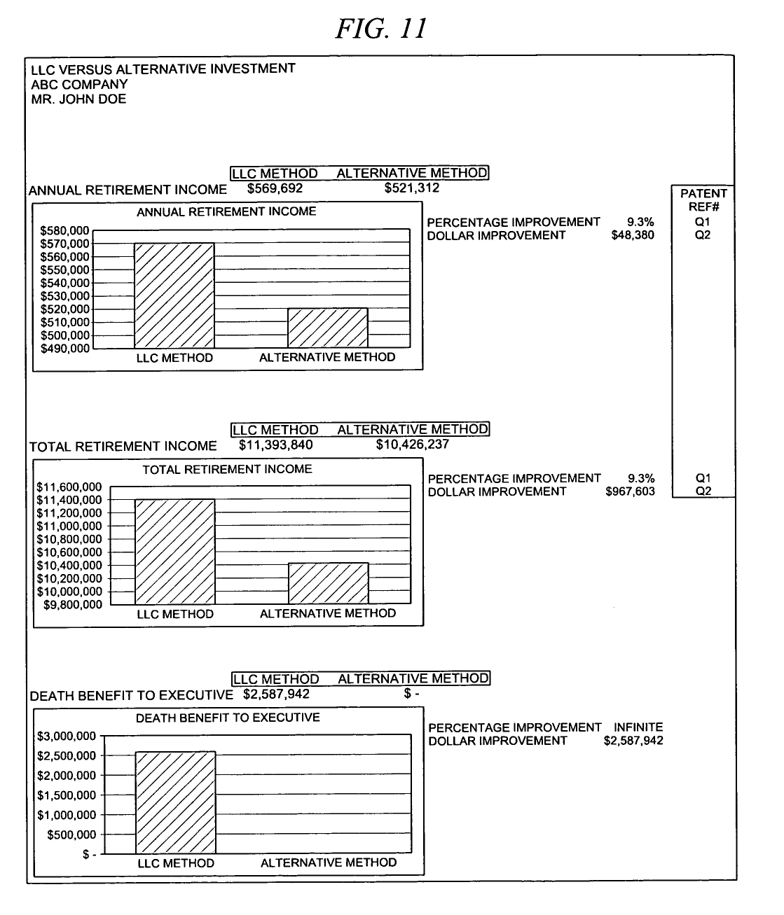

P is then compared to A at step 408 and a percentage and dollar improvement of using the LLC structure is calculated and presented. The percentage difference is “Q1” and the dollar difference is “Q2.” At step 410, the software calculates the rate of return on “New Funds” to be realized by the employer, New Funds (“R”) having been set equal to ((N−J)*H) at step 409. FIG. 10 illustrates a computer display of a spreadsheet with these calculations performed to provide alternative investment baseline information over the period. FIG. 11 is screen providing graphical comparisons between the LLC method according to a benefit program implemented according to an embodiment of the invention and an alternative investment vehicle or methodology with respect to annual and total retirement income and death benefits realized by each.

At step 411, the life expectancy in years of the insured(s) (i.e., the Executive and possibly his/her spouse) on the Preferred Policy is calculated using, for example, life expectancy tables, actuarial charts, etc. This amount in years is “S.” Using “S”, at step 412 the software finds the death benefit of the Preferred Policy at S. This amount is “T.” The rate of return on R is set equal to the present value (PV) of T over S years at step 412 such that R=T. The calculated rate of return on R is “U” which is the compared to G at step 414 to assist the Employer in determining if they should invest in LLC, or in the alternative, secure outside financing. FIG. 12 illustrates how the results of these calculations, the calculated rate of return on R, might be displayed to a user. FIG. 13 shows display of a comparison of U (the calculated rate of return to the Employer) to G (rate of return on invested capital to the Employer).

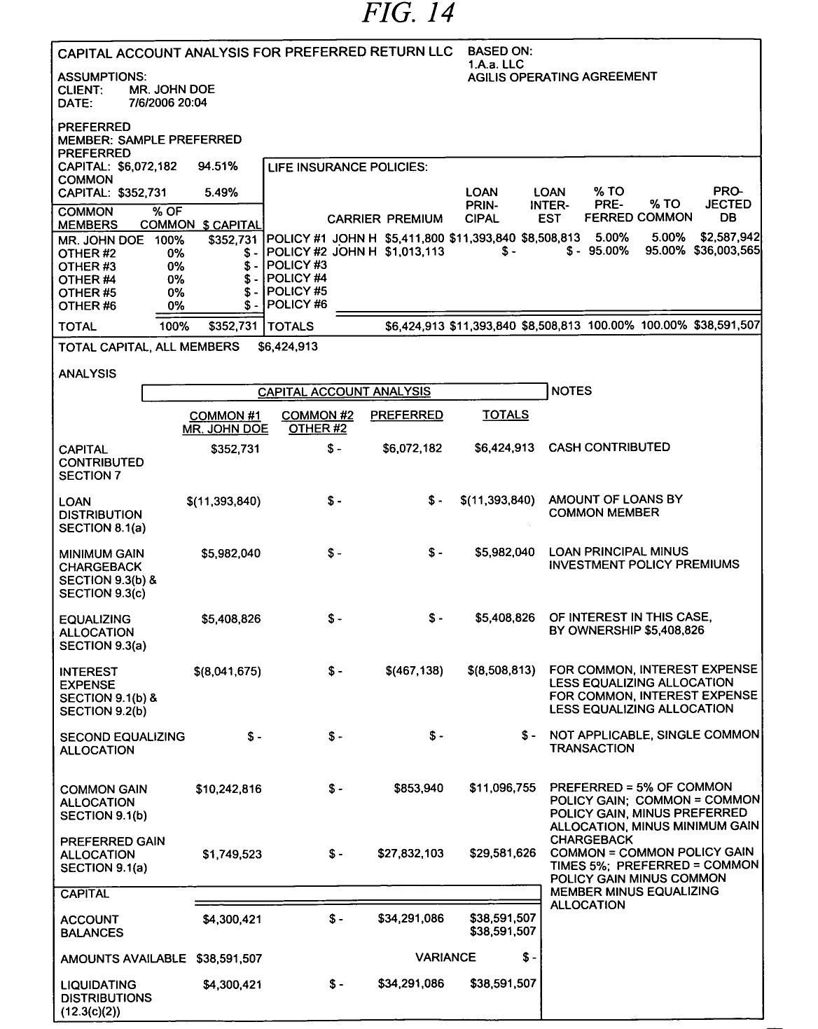

At step 415 the system validates that the use of the various allocations and special allocations of non-recourse debt and tax free income will result in all distributions received by the employer/financing source and employee being equal to their respective basis and capital accounts. The results of the calculations are accumulated, organized and printed (or otherwise displayed) in a visually appealing and informative format for presentation to the employer and employee(s) as show, for example, in FIG. 14.

Upon presentation to the employer/financing source and employee(s), and if the decision is made to proceed and implement the plan, then the software will create a specifications sheet. This specifications sheet will provide the values necessary for the attorney's to properly draft the LLC Operating Agreement(s).

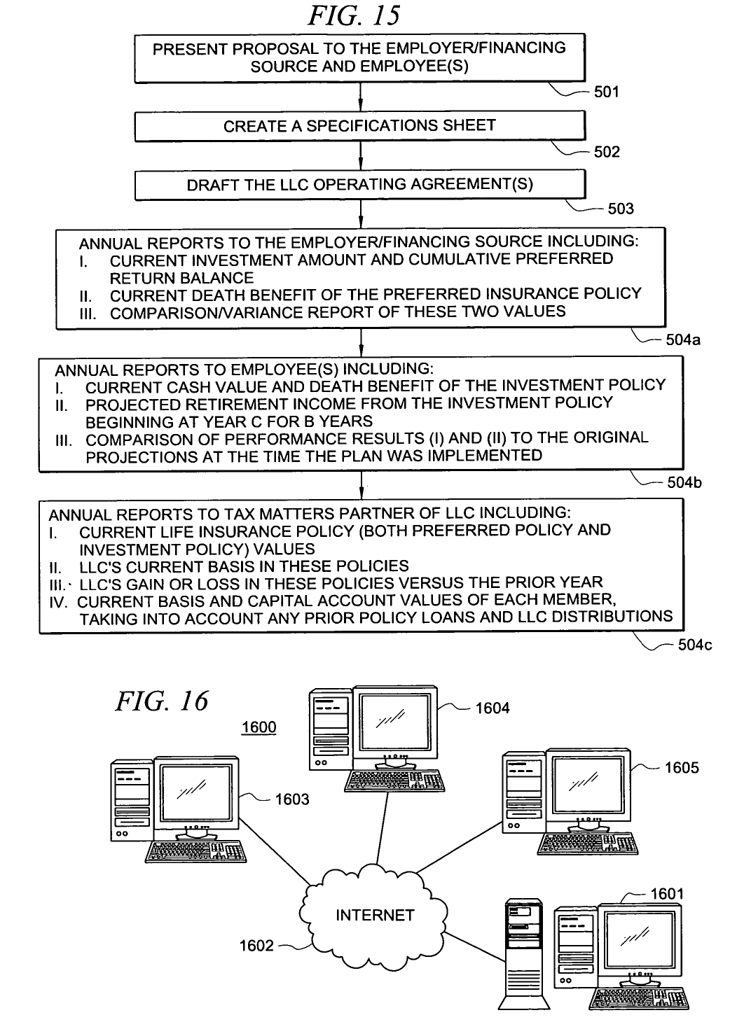

FIG. 15 illustrates steps used to finalize and implement the benefit program. At step 501 the proposed plan is presented to the parties: the Employee and the Sponsor (i.e., Employee or Financing Source) for their review and approval. As a result, the parties generate any additional requirements that, together with the previously generated benefit program requirements, are used to create a specification sheet at step 502 defining an appropriate investment vehicle, e.g., an LLC. As a result, appropriate actions are taken at step 503 to draft an LLC Operations Agreement. At steps 104a, 504b and 504c ongoing annual reports are provided to the Program Sponsor, the Employee (e.g., Executive) and to the person and/or entity responsible for attending to regulating matters of the LLC involving Federal and State tax issues, etc., as follows:

After the transaction is closed, the software will provide annual reports to the employer/financing source, the employee(s), and the Tax Matters Partner of the LLC. These annual reports may include:
a. To the employer/financing source:
   i. The current investment amount and cumulative preferred return balance.
   ii. The current death benefit of the Preferred Insurance Policy.
   iii. A comparison/variance report of these two values.
b. To the employee(s):
   i. The current cash value and death benefit of the Investment Policy.
   ii. The projected retirement income from the Investment Policy beginning at year C for B years.
   iii. How these values compare to the original projections at the time the plan was implemented.
c. To the LLC Tax Matters Partner:
   i. The current life insurance policy (both Preferred Policy and Investment Policy) values.
   ii. The LLC's current basis in these policies.
   iii. The LLC's gain or loss in these policies versus the prior year.
   iv. The current basis and capital account values of each member, taking into account any prior policy loans and LLC distributions.

FIG. 16 is a block diagram of a system that may be used to create and implement a benefit program as described above. System 1600 may include a suitable processing platform such as a workstation or Server 1601 running an appropriate software application such as, for example, Microsoft® Excel® or similar spreadsheet program. The software application may be programmed or otherwise configured to perform processing according to the steps and methods described hereinabove so as to create, implement and monitor a benefit program for one or more employees and one or multiple employers. Server 1601 may be connected to and interfaced with the various parties to the program, information sources, databases, third-parties (e.g., insurance companies, government agencies such as the IRS, etc.) using an appropriate communications medium, e.g., a computer data network such as Internet 1602. For example, Executive Terminal 1603, Employer Terminal 1604 and Financing Source Terminal 1605 may be provided with a suitable interface with Server 1601 to provide, collect and share information to implement and administer a benefit program according to embodiments of the invention. This information may include that necessary to identify Executives that may be suitable for participation, solicit their participation, determine amounts to be invested by each party, select a suitable jurisdiction and optimal organization of an investment vehicle in the selected jurisdiction, specify and design preferred and investment policies, create an operating agreement, and that necessary and/or desirable to implement, track investments and otherwise administer the benefit program.

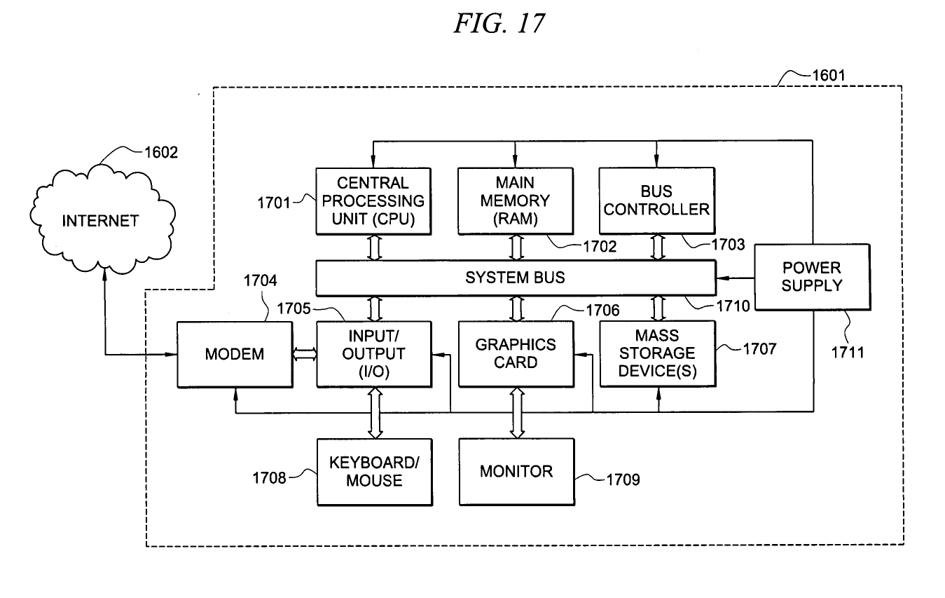

FIG. 17 is a block diagram of Server 1601 in the form of a computer system that may be used as a platform for running software performing steps and methods according to various embodiments of the invention. Server 1601 include a Central Processing Unit (CPU) 1701, Main Memory in the form of RAM 1702, Bus Controller 1703, Modem 1704, Input/Output (I/O) Controller 1705, Graphics Card 1706, Mass Storage Devices 1707, Keyboard and Mouse Devices 1708 and Monitor 1709, each connected directly or indirectly to System Bus 1710. Power Supply 1711 provides suitable power to each of the devices and subassemblies mentioned. Modem 1704 may be any form of data communications interface for providing external connectivity with Internet 1602 or other data network.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for developing, financing and administering an asset-protected executive benefit program, comprising the steps of:
soliciting executive participation though sophisticated forecasting and modeling;
selecting a program sponsor for the group consisting of an employer of said executive and an outside investor;
determining an amount to be capitalized by each of said executive and said program sponsor;
organizing an investment vehicle in an asset-protection friendly jurisdiction;
designing an Preferred Policy to ensure a guaranteed return to said program sponsor;
designing an Investment Policy to meet investment objectives of said program sponsor;
creating an Operating Agreement for said investment vehicle that meets objectives of said executive and said program sponsor, including the ability to allocate non-recourse and excess non-recourse debt and tax-free income; and
providing annual program administration to track investments, partnership allocations, income, and distributions.

2. The method of developing, financing and administering an executive benefit in claim 1, wherein the investment vehicle is an asset-protected limited liability company (LLC).

3. The method of developing, financing and administering an executive benefit in claim 1, wherein said program sponsor receives a guaranteed return on investment.

4. The method of developing, financing and administering an executive benefit in claim 1, wherein the guaranteed return on investment to the program sponsor is secured by a specially designed, escalating death benefit life insurance policy.

5. The method of developing, financing and administering an executive benefit in claim 1, wherein the amount to be capitalized by said program sponsor is in the range of from 75% to 95% of a total amount required to be capitalized.

6. The method of developing, financing and administering an executive benefit in claim 1, wherein the Preferred Policy insures the Executive.

7. The method of developing, financing and administering an executive benefit in claim 1, wherein the investment vehicle will be capitalized for a period of 5-10 years.

8. The method of developing, financing and administering an executive benefit in claim 1, wherein the investment vehicle is formed as a Limited Liability Corporation (LLC) and said Investment Policy is designed to meet the investment objectives of members of the LLC.

9. The method of developing, financing and administering an executive benefit in claim 1, wherein said investment vehicle is implemented by drafting and executing an LLC Operating Agreement.

10. The method of developing, financing and administering an executive benefit in claim 1, wherein additional investments are made based on a pre-determined capitalization schedule.

11. The method of developing, financing and administering an executive benefit in claim 1, wherein preferential treatment are given to payment of premiums for the Preferred Policy followed by premium investments made in the Investment Policy.

12. The method of developing, financing and administering an executive benefit in claim 9, further comprising drafting and executing an LLC Operating Agreement including:
developing a method to allocate non-recourse and excess non-recourse liabilities;
developing a method to allocate tax-free income;
developing a capitalization schedule for the members of the LLC;
identifying life insurance policies to be owned;
identifying rights and obligations of a program manager; and
identifying a guaranteed return to a preferred member.

13. The method of developing, financing and administering an executive benefit in claim 1, wherein the Executive, upon completing an initial LLC capitalization period, is able to instruct the LLC to borrow against the Investment Policy.

14. The method of developing, financing and administering an executive benefit in claim 13, wherein any LLC policy borrowings will be allocated as non-recourse and excess non-recourse debt to the Executive.

15. The method of developing, financing and administering an executive benefit in claim 1, wherein, the investment vehicle comprises a Limited Liability Corporation (LLC) and, upon death of the Executive, the LLC is to receive tax-free death benefits from the insurance policies.

16. The method of developing, financing and administering an executive benefit in claim 15, wherein the LLC receipt of tax-free income is allocated to the basis of the LLC members.

17. The method of developing, financing and administering an executive benefit in claim 15, wherein the LLC will first make a distribution to the Executive or Program Sponsor equal to their initial investment, plus accumulated guaranteed return.

18. The method of developing, financing and administering an executive benefit in claim 15, wherein any remaining funds with then be distributed to the estate of the Executive.

19. A method of administering an asset-protected executive benefit program, comprising the steps of:
identifying financial goals for each party including (i) an executive as a beneficiary of the program and (ii) a program sponsor;
identifying an investment amount based on the goals of each party;
conducting an appraisal to determine how much of an investment vehicle should be capitalized by each party;
organizing said investment vehicle to administer the program;
designing a Preferred Policy to provide a predetermined guaranteed rate of return to the program sponsor;
designing an Investment Policy to satisfy investment objectives of the program sponsor; and
creating an Operating Agreement for the investment vehicle that meets objectives of each party, including the ability to allocate non-recourse and excess non-recourse debt and tax-free income.

20. The method according to claim 19 further comprising the steps of:
selecting said program sponsor from the group consisting of an employer and an outside investor; and
providing annual program administration to properly track investments, partnership allocations, income, distributions and other parameters.

21. A system for administering an asset-protected executive benefit program, comprising:
a computer including a memory storing a set of instruction, said computer executing said set of instructions for
(a) identifying an investment amount based on identified goals of each party, the parties including (i) an executive as a beneficiary of the program and (ii) a program sponsor;
(b) determining how much of an investment vehicle should be capitalized by each party;
(c) providing criteria for a Preferred Policy so as to provide a predetermined guaranteed rate of return to the program sponsor; and
(d) providing criteria for an Investment Policy to satisfy investment objectives of the program sponsor.
